(19) United States
(12) Patent Application Publication
(10) Pub. No.: US 2025/0162121 A1
(43) Pub. Date: May 22, 2025

(54) MULTI-FUNCTION APPARATUS

(71) Applicant: Carine Vinett, New York, NY (US)

(72) Inventors: Carine Prusack, New York, NY (US); Michael Morton, Austin, TX (US)

(21) Appl. No.: 18/955,300

(22) Filed: Nov. 21, 2024

Related U.S. Application Data
(60) Provisional application No. 63/601,615, filed on Nov. 21, 2023.

(51) Int. Cl. B25F 1/04

(52) U.S. Cl. CPC B25F 1/04

(57) ABSTRACT

A hand-held multi-function tool that includes a fastener pull assist that is configured to assist in closing/sealing and/or opening/unsealing an item, a clasping mechanism that is configured to aid in fastening an object and a loop that is configured aid in fastening object.

### CROSS-REFERENCE TO RELATED APPLICATION

This patent application claims benefit to U.S. Provisional Patent Application No. 63/601,615, filed Nov. 21, 2024, which is hereby incorporated by reference in its entirety as part of the present disclosure.

### FIELD OF THE INVENTION

The present disclosure generally relates to a hand-held multi-function tool and more specifically to a hand-held multi-function tool that includes a fastener pull assist that is configured to assist in closing/sealing and/or opening/unsealing an item (e.g., a zipper), a clasping mechanism that is configured to aid in fastening an object (e.g., a piece of jewelry) and a loop that is configured aid in fastening object (e.g., a button).

### SUMMARY OF THE INVENTION

The present disclosure relates generally to a hand-held multi-function apparatus that includes a zipper pull assist that is configured to assist in closing/sealing and/or opening/unsealing an item (e.g., a zipper), a clasping mechanism that is configured to aid in fastening an object (e.g., a piece of jewelry) and a loop that is configured aid in fastening object (e.g., a button). The multi-function apparatus is configured to ensure multiple devices are housed within a single tool with each device configured to aid an individual complete a desired task eliminating the need to have multiple tools to assist with various tasks.

In an embodiment, the present disclosure is directed to a multi-tool apparatus comprising a housing, a fastener pull assist arranged at least in part within the housing, a clasping mechanism rotatably fixed to the housing and a loop rotatably fixed to the housing.

A first rotatable fastener and a second rotatable fastener can be fixed within the housing. The clasping mechanism can be fixed to the first rotatable fastener. The loop can be fixed to the second rotatable fastener.

The housing can include a first opening and a second opening. The clasping mechanism can be rotatable between a first position within the second opening of the housing and a second position where the clasping mechanism extends out of the first opening in the housing. The loop can be rotatable between a first position within the second opening of the housing and a second position where the loop extends out of the second opening of the housing.

The fastener pull assist can be a spring-loaded winding mechanism that is configured to extend from and retract within the housing. The fastener pull assist can includes a clasp external of the housing.

The clasping mechanism can include a spring-tensioned clip that is comprised of a first part and a second part with the first part and the second part interacting with each other to grasp and release an object.

The loop can include a body that is comprised of a first leg, a second leg, a third leg, a fourth leg, a fifth leg, a sixth leg and a seventh leg forming an opening within the body. The loop can have a narrowed section that is configured to aid in directing an object toward and within the slot to secure the object for manipulation thereof.

In another embodiment, the present disclosure is directed to a method of using a multi-tool device, the method comprising the steps of: providing a housing, a fastener pull assist arranged at least in part within the housing, a clasping mechanism rotatably fixed to the housing and a loop rotatably fixed to the housing; rotating at least one of the fastener pull assist, a clasping mechanism and a loop out of the housing; securing an object to or in contact with at least one of the fastener pull assist, a clasping mechanism and a loop; and manipulating the at least one of the fastener pull assist, a clasping mechanism and a loop which the object is secured to or in contact with to aid in completing a task.

### BRIEF DESCRIPTION OF THE DRAWINGS

FIG. 1 is a first perspective view of a multi-tool device according to according to an embodiment of the present disclosure;

FIG. 2 is a top view of the multi-tool device of FIG. 1 showing tools associated with the device in both an open and stored position according to an embodiment of the present disclosure;

FIG. 3 is a second perspective view of the multi-tool device of FIG. 1; and

FIG. 4 is a third perspective view of the multi-tool device of FIG. 1.

### DETAILED DESCRIPTION OF EMBODIMENTS OF THE INVENTION

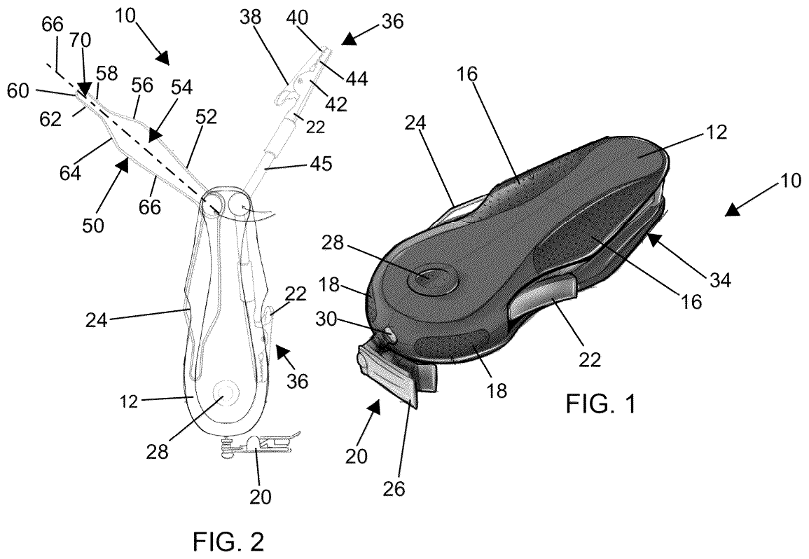

With reference now to the drawings and in particular FIGS. 1-4, embodiments of a multi-tool device of the present disclosure, which is generally designated by reference numeral 10, will be described.

FIGS. 1-4 depict various view of an embodiment of the multi-tool device 10. The multi-tool device 10 includes a housing or main body 12 that can include over molding 16, 18 to enhance friction and in turn aid in gripping the device 10 so that the multi-tool device 10 does not slip out of a user's hand.

As shown in FIGS. 1-4, the multi-tool device 10 includes a zipper-pull assist 20, a clasping device 22 to aid in fastening an object such as a piece of jewelry and a loop 24 that is configured aid in fastening an object such as a button. While the number of mechanisms shown is the three previously mentioned, the multi-tool device 10 could include additional mechanisms as well.

The fastener pull assist apparatus 20 is configured to be affixable to a slidable fastener located on a rear side of a garment to aid in closing/sealing and/or opening/unsealing the garment (e.g., zipper of the garment). The fastener pull assist apparatus 20 is a spring-loaded, ratcheting, winding mechanism that allows for the extension and retraction of a cord or the like (not shown). In an embodiment, a clasp 26 can be fixed to the cord external of the housing 12 to aid in gripping the fastener pull. The cord can be freely pulled out of the housing 12 and retracted therein by depressing a button 28, which in turn causes the winding mechanism to wind the cord thereabout. The length of the cord extension can be controlled intermittently by releasing the button 28 as the cord retracts. It is noted that the cord can extend through a first opening 30 formed in the housing 12.

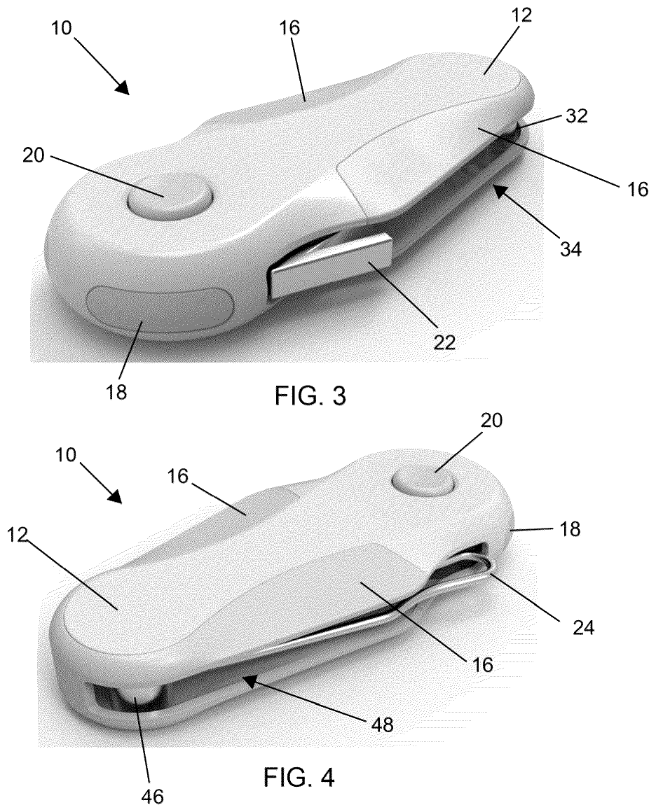

In an embodiment, the clasping mechanism 22 is fixed to the multi-tool device 10 by a first pin 32 or similar fastener that is rotatable within the housing 12 of the multi-tool device 10. As shown in FIG. 2, the clasping mechanism 22 is rotatable between a first or stored position within a second opening 34 of the multi-tool device 10 and a second or use position where the clasping mechanism 22 is rotated out of the second opening 34 (see FIG. 3) in the housing 12 of the multi-tool device 10. The clasping mechanism 22 can include a spring-tensioned clip 36 that is comprised of a first part 38 that can include a plurality of teeth 40 and a second part 42 that is fixed to the first part 38 that can include a plurality of teeth 44. The clasping mechanism 22 can be tensioned in a closed position. An arm 45 can be fixed to the clip 36 at one end and fixed to the first pin 32 at a second end thereof.

An individual can grasp the clip 36 with a first finger contacting the first part 38 of the clip 36 and a second finger contacting the second part 42 of the clip 36. The individual can then squeeze the clip 36 causing at least one of the first part 38 and the second part 42 to move away from the other part and creating gap therebetween. In an open position, the individual can place an object between the first part 38 and the second part 42 of the clip 36 and then release pressure applied to the clip 36 such that the object is releasably fixed between the first part 38 and second part 42 of the clip 36. For example, if the object is a piece of jewelry such as a bracelet or necklace, with the assistance of the clasping mechanism 22, the piece of jewelry can be easily manipulated to aid in clasping or unclasping the piece of jewelry.

In an embodiment, the loop 24 is fixed to the multi-tool device 10 by a second pin 46 or similar fastener that is rotatable within a housing 12 of the multi-tool device 10. As shown in FIG. 2, the loop 24 is rotatable from a first or stored position within a third opening 48 (see FIG. 4) of the multi-tool device 10 and a second or use position where the loop 24 is rotated out of the third opening 48 in the housing 12 of the multi-tool device 10. The loop 24 includes a body 50 comprised of a first leg 52, a second leg 54, a third leg 56, a fourth leg 58, a fifth leg 60, a sixth leg 62 and a seventh leg 64. The first leg 52 and the seventh leg 64 are each connected at one end to the second pin 46 and extend outwardly at angles therefrom away from an axis 66. The second leg 54 extends from the other end of the first leg 52 at an angle toward the axis 66 and the sixth leg 62 extends from the other end of the seventh leg 64 at an angle toward the axis 66 such that the second leg 54 and the sixth leg 62 narrow an opening 68 of the loop 24 and aid in directing the button toward a slot 70 formed in combination by the third leg 56, the fourth leg 58 and the fifth leg 60.

The loop 24 can aid in fastening an object such as a button. For example, when the loop 24 is used to fasten a button, threading securing the button to an object such as a shirt is slide within the slot 70 while the button is slid in unison above the slot 70 so that the individual can manipulate the button via the loop 24 through a mating opening in the object and secure the button in a fastened position. The loop 24 can, for example, be comprised of a wire, plastic or a similar material.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A multi-tool apparatus, comprising:
a housing;
a fastener pull assist arranged at least in part within the housing;
a clasping mechanism rotatably fixed to the housing;
and a loop rotatably fixed to the housing.

2. The multi-tool apparatus of claim 1, wherein the fastener pull assist is spring-loaded winding mechanism that is configured to extend from and retract within the housing.

3. The multi-tool apparatus of claim 1, wherein the fastener pull assist includes a clasp external of the housing.

4. The multi-tool apparatus of claim 1, wherein a first rotatable fastener and a second rotatable fastener are fixed within the housing.

5. The multi-tool apparatus of claim 4, wherein the clasping mechanism is fixed to the first rotatable fastener.

6. The multi-tool apparatus of claim 1, wherein the housing has a first opening and a second opening.

7. The multi-tool apparatus of claim 6, wherein the clasping mechanism is rotatable between a first position within the second opening of the housing and a second position where the clasping mechanism extends out of the first opening in the housing.

8. The multi-tool apparatus of claim 1, wherein the clasping mechanism includes a spring-tensioned clip that is comprised of a first part and a second part with the first part and the second part interacting with each other to grasp and release an object.

9. The multi-tool apparatus of claim 4, wherein the loop is fixed to the second rotatable fastener.

10. The multi-tool apparatus of claim 6, wherein the loop is rotatable between a first position within the second opening of the housing and a second position where the loop extends out of the second opening of the housing.

11. The multi-tool apparatus of claim 1, wherein the loop includes a body comprised of a first leg, a second leg, a third leg, a fourth leg, a fifth leg, a sixth leg and a seventh leg forming an opening within the body.

12. The multi-tool apparatus of claim 1, wherein the loop has a narrowed section that is configured to aid in directing an object toward and within the slot to secure the object for manipulation thereof.

13. A method of using a multi-tool device, the method comprising:
providing a housing, a fastener pull assist arranged at least in part within the housing, a clasping mechanism rotatably fixed to the housing and a loop rotatably fixed to the housing;
rotating at least one of the fastener pull assist, a clasping mechanism and a loop out of the housing;
securing an object to or in contact with at least one of the fastener pull assist, a clasping mechanism and a loop; and
manipulating the at least one of the fastener pull assist, a clasping mechanism and a loop which the object is secured to or in contact with to aid in completing a task.
